(19) United States
(12) Patent Application Publication
(10) Pub. No.: US 2005/0157377 A1
(43) Pub. Date: Jul. 21, 2005

(54) Portable electronic device with a laser projection display

(76) Inventors: Ron Goldman, Cold Spring Harbor, NY (US); Miklos Stern, Woodmere, NY (US)

Correspondence Address: Terry D. Morgan, P.C.;Williams, Morgan & Amerson, Suite 1100, 10333 Richmond, Houston, TX, 77042, US

(21) Appl. No.: 10/909,964

(22) Filed: Jul. 31, 2004

Related U.S. Application Data
(60) Provisional application No. 60/538,064, filed on Jan. 20, 2004.

(51) Int. Cl. G02F 1/29; G02B 26/08

(52) U.S. Cl. 359/298

(57) ABSTRACT

A portable electronic device, such as a Personal Digital Assistant (PDA) is coupled with a foldable keyboard and a laser projection device (LPD). The LPD may be controllable to display in a first format or size on a back lit screen contained with the PDA or in a second format or size on an external screen or wall.

### BACKGROUND OF THE INVENTION

1. Field of the Invention

This invention relates generally to electronic displays, and, more particularly, to a multi-color Laser Projection Display (LPD) that may be employed on a portable electronic device, such as a personal digital assistant (PDA), a cellular telephone, and the like.

2. Description of the Related Art

In the field of portable electronic devices, there is commonly a conflict between the size of the device and its usefulness. That is, on the one hand, the smaller a device is, the greater its portability. On the other hand, the smaller a device is, the less functionality it typically has. This aspect is particularly true for electronic displays commonly used in portable electronic devices. Small displays enhance portability, but they are difficult to see and they limit the amount of useful information that can be displayed. Large displays, however, reduce portability and are often responsible for substantially reduced battery life.

For example, PDAs are typically capable of running word processing programs, but their displays are so limited in size that only a few lines of text can be displayed. This limited display capability reduces the usefulness of the PDA as a word processor. Similarly, cellular telephones and PDAs are functionally equipped to receive and send email messages, however their small displays make reading and writing long messages difficult.

The present invention is directed to overcoming, or at least reducing, the effects of one or more of the problems set forth above.

### SUMMARY OF THE INVENTION

In one aspect of the instant invention, an electronic device is provided. The electronic device is comprised of a laser projection display and a keyboard coupled to the laser projection display.

In another aspect of the instant invention, a personal digital assistant is provided. The personal digital assistant is comprised of a laser projection display and a keyboard coupled to the personal digital assistant.

### BRIEF DESCRIPTION OF THE DRAWINGS

The invention may be understood by reference to the following description taken in conjunction with the accompanying drawings, in which like reference numerals identify like elements, and in which:

FIG. 1 is a stylistic block diagram of a top level view of one embodiment of a laser projection device (LPD) that may be employed in the present invention;

FIG. 2 is a stylistic view of a viewing surface shown in FIG. 1;

FIGS. 3A and 3B depict a top view of a scanning device at various times during its operation;

FIG. 4 is a stylistic view of a portable electronic device employing an LPD of the type shown in FIG. 1;

FIG. 5 is a stylistic view of the portable electronic device of FIG. 4 in a partially deployed configuration;

FIG. 6 is a stylistic view of the portable electronic device of FIG. 4 in a substantially fully deployed configuration; and

FIG. 7 depicts an alternative embodiment of portable electronic device employing an LPD.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The following co-pending applications are hereby incorporated by reference herein in their entirety: Method and Apparatus for Aligning a Plurality of Lasers in an Electronic Display Device, by Mik Stern et. al.; Method and Apparatus for Controllably Reducing Power Delivered by a Laser Projection Display, by Mik Stern et. al.; Method and Apparatus for Displaying Information in Automotive Applications Using a Laser Projection Display, by Narayan Nambudiri et. al.; Method and Apparatus for Providing an Interface Between a Liquid Crystal Display Controller and a Laser Projection Display, by Narayan Nambudiri et. al.; A Color Laser Projection Display by Paul Dvorkis et. al.; Method and Apparatus for Capturing Images Using A Color Laser Projection Display, by Chinh Tan et. al.; A Laser Projection Display, by Ron Goldman et. al.; Method and Apparatus for Controllably Compensating for Distortions in a Laser Projection Display, by Carl Wittenberg et. al.; and Method and Apparatus for Controllably Modulating a Laser in a Laser Projection Display, by Dmitriy Yavid et. al.

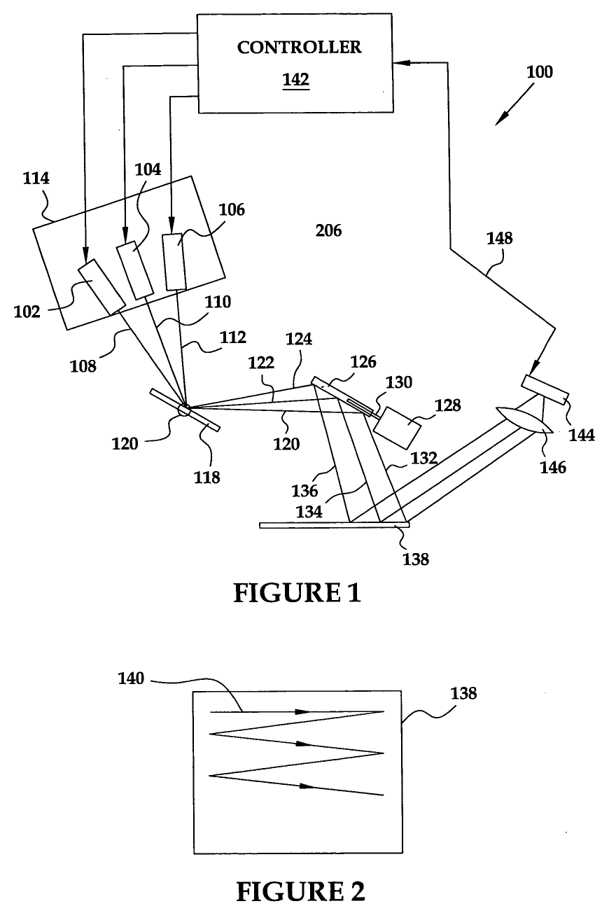

Turning now to the drawings, and specifically referring to FIG. 1, a stylistic block diagram of a laser projection display (LPD) 100, in accordance with one embodiment of the present invention, is shown. In the illustrated embodiment, the LPD 100 includes three lasers 102, 104, 106, each capable of emitting a beam of light 108, 110, 112 consisting of a unique color, such as red, green or blue. Those skilled in the art will appreciate that the number of lasers and the color of light emitted therefrom may be varied without departing from the spirit and scope of the instant invention.

The lasers 102, 104, 106 are arranged in a common plane 114 with the beams of light 108, 110, 112 being angularly directed relative to one another to fall on a substantially common location 116 on a first scanning device, such as a first scanning mirror 118, from where they are reflected as beams of light 120, 122, 124. In the illustrated embodiment, the first scanning mirror 118 oscillates on an axis 120 at a relatively high rate (e.g., about 20-30 KHz). Rotation or oscillation of the first scanning mirror 118 causes the beams of light 108, 110, 112 to be moved. That is, as the angular position of the first scanning mirror 118 alters, so to does the angle of reflection of the beams of light 120, 122, 124 from the first scanning mirror 118. Thus, as .the mirror oscillates the reflected beams of light 120, 122, 124 are scanned to produce movement of the beams of light 120, 122, 124 along one component of the two-dimensional display.

The second component of the two-dimensional display is produced by a second scanning device, such as a mirror 126. In the illustrated embodiment, the second mirror 126 is coupled to a motor 128 at a pivot point 130 so as to produce rotational or oscillating movement about an axis that is substantially orthogonal to the axis of rotation of the first mirror 118. The beams of light 120, 122, 124 are reflected off of the second mirror 126 as beams of light 132, 134, 136 and directed to a viewing surface 138. The viewing surface 138 may take on any of a variety of forms without departing from the spirit and scope of the instant invention. For example, the viewing surface 138 may be a fixed screen that may be front or back lit by the lasers 102, 104, 106 and may be contained in a housing (not shown) that is common with the LPD 100, or alternatively, the viewing surface 138 may take the form of any convenient, generally flat surface, such as a wall or screen, spaced from the LPD 100.

The second mirror 126 oscillates or rotates at a relatively slow rate, as compared to the rate of the first mirror 118 (e.g., about 60 Hz). Thus, it will be appreciated that, as shown in FIG. 2, the beams of light 132, 134, 136 generally follow a path 140 on the display surface 138. Those skilled in the art will appreciate that the path 140 is similar in shape and concept to a raster scan commonly employed in cathode ray tube televisions and computer monitors.

While the instant invention is described herein in the context of an embodiment that employs separate first and second scanning mirrors 118, 126, those skilled in the art will appreciate that a similar path 140 may be produced by using a single mirror. The single mirror would be capable of being moved about two axis of rotation to provide the fast and slow oscillating movements along two orthogonal axes.

As is apparent from FIG. 1, owing to the angular positioning of the lasers 102, 104, 106, even though the lasers 102, 104, 106 have been arranged mechanically and optically to deliver the beams of light 108, 110, 112 within the same plane 114 and at the same point (on the rotational axis 120) on the mirror 118), each has a different angle of reflection, which causes the beams of light 120, 122, 124 to diverge. A controller 142 is provided to controllably energize the lasers 102, 104, 106 to effectively cause the beams of light 120, 122, 124 to be collinear, such that they may be reflected off of the second mirror 126 and delivered to the same point on the viewing surface 138 relatively independent of the distance of the viewing surface 138 from the second mirror 126.

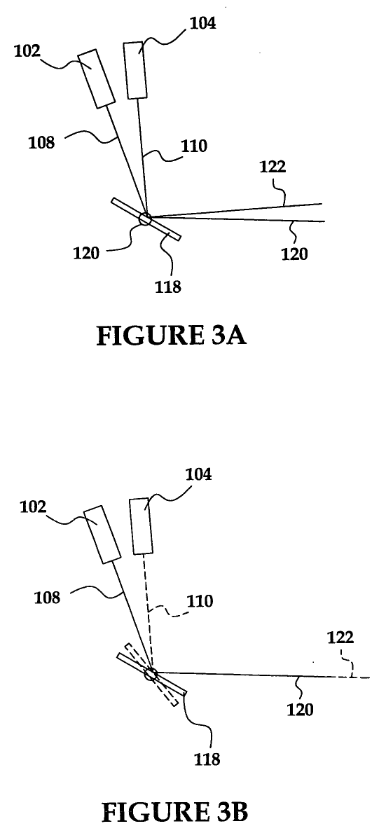

Turning now to FIGS. 3A and 3B, the operation of the controller 142 to cause the beams of light 120, 122, 124 to be collinear is discussed. To simplify the discussion, only two lasers 102, 104 are illustrated in FIG. 3, but those skilled in the art will appreciate that the concepts discussed herein may be extended to three or more lasers without departing from the spirit and scope of the instant invention. As shown in FIG. 3A, if the lasers 102, 104 are energized simultaneously, the reflected beams of light 120, 122 diverge. However, as shown in FIG. 3B, if the lasers 102, 104 are energized at slightly different times, then the beams of light 120, 122 can be made to follow a single, common path (i.e., the beams of light 120, 122 are collinear). For example, if the laser 102 is energized at a first time t1, then the mirror 118 will be at a first position, as represented by the solid lines, and the beam of light 108 will reflect off of the mirror 118 as the beam of light 120. Subsequently, if the laser 104 is energized at a second time t2, then the mirror 118 will be at a second position, as represented by the dashed lines, and the beam of light 110 will reflect off of the mirror 118 as the beam of light 122. By precisely controlling the time t2, the mirror 118 will be in a position to accurately reflect the beam of light 122 along substantially the same path as the beam of light 120.

Thus, through the operation of the controller 142, the beams of light 120, 122 are substantially collinear, but are slightly displaced in time. That is, the beams of light 120, 122 will now both be projected onto substantially the same point on the display surface 138, but at slightly different times. However, owing to the persistence of the human eye, the variation in timing is not detectable. That is, in the case of the three laser system described in FIG. 1, each of the lasers 102, 104, 106 will controllably deliver laser light of a unique color and intensity to substantially the same point on the viewing surface 132 within a relatively short window of time. The human eye will not detect the three separate colors, bur rather will perceive a blending of the three light beams such that a consistent and desired hue appears at that point on the viewing surface. Those skilled in the art will appreciate that this process may be repeated numerous times along the path 140 to recreate a picture on the viewing surface 132.

In the instant invention, the LPD is used to improve the ease of use of portable electronic devices, such as PDAs, cellular telephones, DVD players, and the like. The attached drawings show an embodiment of the instant invention that combines the LPD with foldout keyboards to create a small PDA device that can function as a full fledged computer with convenient input/output functionality.

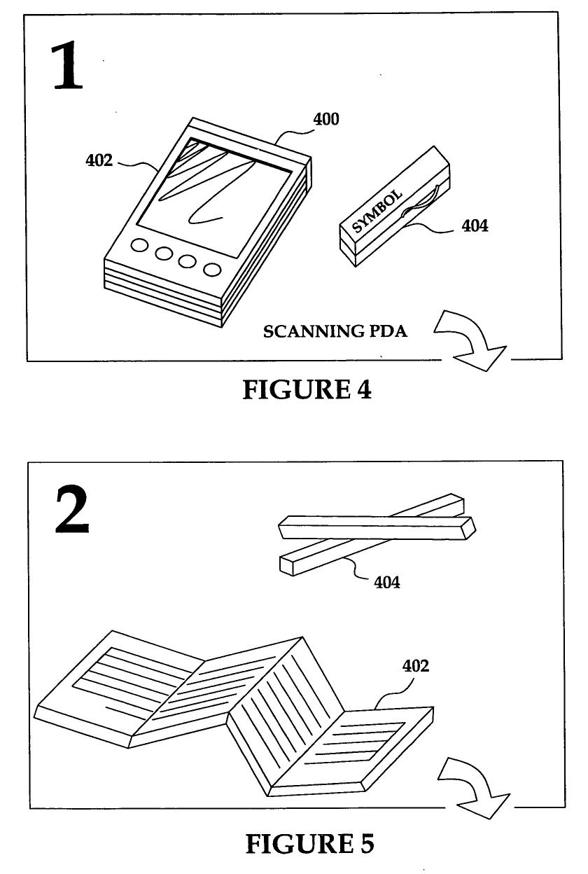

FIG. 4 shows a PDA 400 with a keyboard 402 folded behind it. In this mode, the PDA is similar to a familiar Pal or iPack device, with perhaps increased thickness due to the keyboard 402 folded behind it. The folded keyboard 402 can either be permanently attached to the PDA 400, or can be a detachable accessory.

A foldable projection screen 404 can be provided as an integral device or as a detachable unit. Those skilled in the art will appreciate that the use of an LPD may allow the PDA 400 and keyboard 402 to be used without the projection screen 404. Rather, the LPD may be arranged and configured to display on any convenient flat surface, such as a wall.

FIG. 5 shows the keyboard 402 and the projection screen 404 in partially unfolded positions. The keyboard 402 is visible on the top, while the PDA 400 is on the reverse or bottom side of one of the foldouts. Above the keyboard 402 is the partially unfolded projection screen 404.

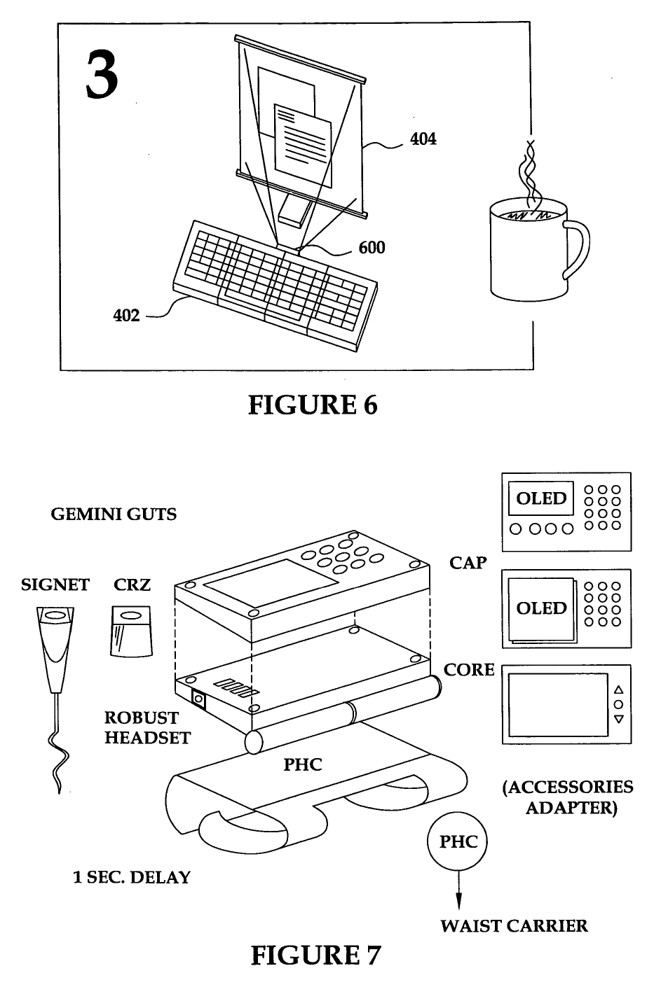

FIG. 6 shows the fully unfolded keyboard 402, with the LPD 600 projecting on the also fully unfolded projection screen 404. Depending on the size requirement of the projection screen 404, it can be permanently attached to the unit. If the projection screen 404 is attached to the keyboard 402, it may be closer to the LPD 600, and hence the size of an image displayed on the projection screen 404 may be smaller. It should be noted, that the LPD 600 can project the display on any available surface. The foldable projection screen 404 may be provided for added convenience. Furthermore, the projection screen 404 be designed to be a good reflector for the laser wavelength or wavelengths for red-green-blue color displays, while it reduces the reflection of other wavelengths. Hence it would reduce the reflection of ambient light incident on the screen, and therefore improve the contrast of the display. Thus, in some applications, it may be useful to provide a projection screen that is specifically tailored to the characteristics of the LPD 600, rather than use a randomly available flat surface, which may have poor reflection and absorption characteristics.

It should be noted that when the PDA 400 and keyboard 402 are oriented in the folded position, as shown in FIG. 4, a display region 406 may be viewed by the user of the PDA 400. The display region 406 may take the form of a back projection screen such that laser light from the LPD 600 may be scanned onto a reverse side of the back lit projection screen 406 for viewing by the operator of the PDA 400. The back lit projection screen may take on any of a variety of forms known to those skilled in the art such that the material comprising the back projection screen allows a substantial portion of the laser light from the LPD 600 to pass therethrough and be viewed by an operator of the PDA 400.

In one embodiment of the PDA 400, the LPD 600 may be arranged to move between first and second positions. In the first position, the LPD 600 would be arranged to project laser light onto the reverse side of the back projection screen 406. In the second position, the LPD 600 would be arranged to project laser light outward and onto the projection screen 404 or any desirable relatively flat surface external to the PDA 400. Those skilled in the art will appreciate that the first and second positions may be achieved by changing the orientation of the LPD 600, by varying the optical path through which the laser light travels, or by a combination of both. The optical path may be varied by alternatively inserting or removing one or more optical elements, such as mirrors, lenses, or the like, into the optical path of the laser light. In this manner, the laser light could be redirected to either fall on the back lit projection screen 406 or the projection screen 404, depending on the operating mode selected by the operator of the PDA 400. For example, in some applications, the operator may desire to enter and access limited amounts of information. In this mode of operation, the PDA 400 may be arranged as is shown in FIG. 4 where the relatively small display region is visable and a relatively few buttons or switches are available for data entry. Alternatively, where larger amounts of information are to be viewed, but only limited data is to be entered, then the PDA 400 may be configured in the folded position of FIG. 4, but the optical path may be oriented in the second position so that a larger, easier to read display may be projected onto the projection screen 404. In a third mode of operation where larger amounts of data may need to be entered, the keyboard 402 may be unfolded into the arrangement shown in FIG. 6 where the operator has access to a substantially larger number of input devices, such as a conventional keyboard arrangement.

In a fourth or hybrid mode of operation, the keyboard 402 may be partially unfolded, for example to expose a portion of the keyboard 402 for access by an operator. In this partially unfolded mode of operation, the keyboard 402 may be used for limited entry of data. For example, in the partially unfolded mode of operation, the exposed portion of the keyboard may be a number pad so that numerical data may be entered, such as during the operation of the PDA 400 as a calculator or spreadsheet. In this fourth mode of operation, the operator may select the LPD 600 to provide the display to the internal screen 406 or the external screen 404. Those skilled in the art will appreciate that when the LPD 600 is projecting an image on a back lit screen its appearance may be reversed, as opposed to when the LPD 600 is projecting an image on a front lit screen. Those skilled in the art will appreciate that the image may be reversed through software control of the LPD 600 or by varying the optical path through which the laser light is delivered. This reversal may be programmed to occur automatically, depending upon the screen that is currently being utilized or it may be controlled by the operator by manually selecting a switch or physically altering the optical path through which the laser light is delivered.

In an alternative embodiment of the instant invention, it may be useful in some applications for the PDA 400 to switch between display modes, depending upon whether the LPD 600 is configured to display on the relatively small screen 406 or the larger screen 404. That is, when the PDA 400 “knows” that the LPD 600 is configured to display on the small screen 406, it may be programmed to display using larger fonts and icons and/or to limit the amount of data presented on the screen 406. However, when the PDA 400 “knows” that the LPD 600 is configured to display on the relatively larger screen 404, it may be programmed to use smaller fonts or icons and/or to present larger amounts of data on the screen 404.

FIG. 7 shows some additional embodiments and possible ways of housing the folded projection screen.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

1. An electronic device, comprising:
a laser projection display; and
a keyboard coupled to said laser projection display.

2. An electronic device, as set forth in claim 1, wherein the laser projection display is configured to selectively project laser light onto at least one of a first and second display region.

3. An electronic device, as set forth in claim 2, wherein the laser projection display is adapted to project laser light onto a back lit screen in the first display region.

4. An electronic device, as set forth in claim 3, wherein the laser projection display is adapted to project laser light onto a front lit screen in the second display region.

5. An electronic device, as set forth in claim 2, wherein the laser projection display is adapted to project laser light onto a screen within the electronic device.

6. An electronic device, as set forth in claim 5, wherein the laser projection display is adapted to project laser light onto a screen external to the electronic device.

7. An electronic device, as set forth in claim 1, wherein the keyboard has at least two operating positions.

8. An electronic device, as set forth in claim 7, wherein the keyboard is operable in the first position to input data or control signals to the electronic device.

9. An electronic device, as set forth in claim 8, wherein the keyboard is operable in the second position for limited input of data or control signals to the electronic device.

10. An electronic device, as set forth in claim 1, wherein the keyboard is movable between a folded and an unfolded position.

11. A personal digital assistant, comprising:
a laser projection display; and
a keyboard coupled to said laser projection display.

12. A personal digital assistant, as set forth in claim 11, wherein the laser projection display is configured to selectively project laser light onto at least one of a first and second display region.

13. A personal digital assistant, as set forth in claim 12, wherein the laser projection display is adapted to project laser light onto a back lit screen in the first display region.

14. A personal digital assistant, as set forth in claim 13, wherein the laser projection display is adapted to project laser light onto a front lit screen in the second display region.

15. A personal digital assistant, as set forth in claim 12, wherein the laser projection display is adapted to project laser light onto a screen within the personal digital assistant,.

16. A personal digital assistant, as set forth in claim 15, wherein the laser projection display is adapted to project laser light onto a screen external to the personal digital assistant,.

17. A personal digital assistant, as set forth in claim 11, wherein the keyboard has at least two operating positions.

18. A personal digital assistant, as set forth in claim 17, wherein the keyboard is operable in the first position to input data or control signals to the personal digital assistant.

19. A personal digital assistant, as set forth in claim 18, wherein the keyboard is operable in the second position for limited input of data or control signals to the personal digital assistant.

20. A personal digital assistant, as set forth in claim 11, wherein the keyboard is movable between a folded and an unfolded position.
